(19) United States
(12) Patent Application Publication
(10) Pub. No.: US 2020/0004833 A1
(43) Pub. Date: Jan. 2, 2020

(54) METHOD AND SYSTEM FOR MANAGING A TIME-BASED DATABASE FOR CONTEXTUAL SEARCHING AND COMMENTING ON MULTIMEDIA

(71) Applicant: SOFASH INC., Wilmington, DE (US)

(72) Inventors: Assi OREN, Tel Aviv (IL); Rona Shaanan, Tel Aviv (IL)

(73) Assignee: SOFASH INC., Wilmington, DE (US)

(21) Appl. No.: 16/021,456

(22) Filed: Jun. 28, 2018

(51) Int. Cl. G06F 17/30

(52) U.S. Cl. CPC G06F 17/30044; H04L 67/42; G06F 17/3002; G06F 17/30174

(57) ABSTRACT

A system and a method of managing a time-based database for contextual searching and commenting are provided herein. The method may include the following steps: identifying a multimedia file consumed by one or more users; uploading, from a database, a time-lined data structure associated with the identified multimedia file, wherein the time-lined data structure holds meta data relating to at least one of: content of the identified multimedia file, and production of the multimedia file; and synchronizing the time-lined data structure with a time line of the identified multimedia file. Optionally, the method may also include the step of enabling the one or more users to apply a search or an editing operation to the time-lined data structure. The system may implement the method in a server-client configuration.

### FIELD OF THE INVENTION

The present invention relates generally to the field of time-dependent databases, and more particularly, to searching and commenting on multimedia based on such databases.

### BACKGROUND OF THE INVENTION

Prior to the background of the invention being set forth, it may be helpful to provide definitions of certain terms that will be used hereinafter.

The term “multimedia” as used herein is generally defined as any video file or audio file in any digital format that can either be streamed or downloaded and watched locally.

The term “Internet television” or “online television” as used herein is the digital distribution of television content, such as TV shows, via the public Internet.

The term “commenting” as used herein refers to the act of commenting in response to watching a show or listening to a podcast. Commenting may be carried out on a blog, an established publisher, a wiki site and any kind of website. The commentary can be made about any TV, movie or podcast content irrespective of the platform.

The term “content items” as used herein relates to items that form part of what is being seen or heard in the multimedia file. These content items may include characters, story locations, artifacts, music, dialogues and monologues.

The term “production items” as used herein relates to items that do not form part of the multimedia file but are rather related to the creation or making of the multimedia file and can be derived by external sources. These content items may include cast, crew, filming locations, production equipment and art, post-production effects, related articles, behind the scenes, critiques, awards, nominees, and promotions. The definition of production items is a residual definition in the sense that any item related to the multimedia file that is not a content item is indicated as a production item.

The term “timecode” as used herein relates in the context of video or audio production to a sequence of numeric codes generated at regular intervals by a timing synchronization system. Timecode is used in any application which requires temporal coordination or logging of recording or actions, such as videos, audio books or podcasts.

Today, internet television, also known as over the top (OTT), is becoming ever more popular. However, the potential of integrating the viewing experience with open information on the web remains untapped.

Current OTT services are lagging behind the need of the users to discover show-related content in a contextual manner. Currently, viewers or listeners (herein users) who search for show-related content need to move away from the screen on which the show is displayed, and to do so in search engines that lack awareness to what show is being watched and what is its current time. Online search results are usually organized by users' location, users' profile, popularity of search terms, but not by relevancy to multimedia's time-codes or scenes.

Some existing show-related content creation is currently carried out over blogs, social platforms and dedicated websites in which communities of fans (particularly relating to a series) share their comments.

These comments may be in the form of: explanation of narrated terms; links to websites where merchandise is being sold, or music is being played or sold, actors and characters profiles; names of filming locations; and personal views and thoughts of the users on actors, scenes and storylines.

However, commenting methods available today either lack the ability of coupling a comment to the scene or time-code it is referring to, or are restricted to embedding the comments within the particular multimedia file, or platform on which it is streamed.

An ongoing challenge of OTT TV providers and affiliated industries is that nowadays people are expecting to find information in a contextual manner, including show-related information while watching TV.

Yet another challenge is the need of users to be able to comment on TV content in a contextual manner, whereas the commenting is independent of the various platforms on which the multimedia file is streamed on.

### SUMMARY OF THE INVENTION

Some embodiments of the present invention provide a system and a method of managing a time-based database for contextual searching and commenting. The method may include the following steps: identifying a multimedia file watched by one or more users; uploading, from a database, a time-lined data structure associated with the identified multimedia file, wherein said time-lined data structure holds meta data relating to at least one of: content of the identified multimedia file, and production of the multimedia file; and synchronizing the time-lined data structure with a time line of the identified multimedia file. Optionally, the method may also include the step of enabling the one or more users to apply an editing operation to said time-lined data structure.

Advantageously, some embodiments of the present invention do not require permission or access to the multimedia file itself. Thus, by using the time-lined data structure associated with the identified multimedia file in accordance with some embodiments of the present invention, a user can refer to a multimedia file by commenting and tagging in a manner that is synched to its timecode, without the need to be part of the platform that provides the multimedia file.

Further advantageously, in accordance with some embodiments of the present invention, in addition to being able to comment without the need to be part of the streaming platform, the users may also discover the comments while watching a show. Both actions (commenting and discovering) are available without being part of or dependent upon the platform providing/streaming the multimedia file.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating non-limiting exemplary architecture in accordance with some embodiments of the present invention;

FIG. 2 is a high-level flowchart illustrating non-limiting exemplary user interface flow of the method in accordance with some embodiments of the present invention;

FIG. 3 is a diagram illustrating non-limiting exemplary architecture of the time lined data structure in accordance with embodiments of the present invention; and

FIG. 4 is a high-level flowchart illustrating non-limiting exemplary method in accordance with embodiments of the present invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that, throughout the specification, discussions utilizing terms such as “processing,” “computing,” “calculating,” “determining,” or the like, refer to the action and/or processes of a computer or computing system.

Such a computer or a computing system is interpreted to include any similar electronic computing device that manipulates and/or transforms data represented as physical, such as electronic, quantities within the computing system's registers and/or memories into other data similarly represented as physical quantities within the computing system's memories, registers or other such information storage, transmission or display devices.

According to some embodiments of the present invention, a method of managing a time-based database for contextual searching and commenting is provided herein. The method may include the following steps: identifying a multimedia file watched by one or more users; uploading, from a database, a time-lined data structure associated with the identified multimedia file, wherein said time-lined data structure holds metadata relating to at least one of: content of the identified multimedia file, and production of the multimedia file; and enabling the one or more users to apply an editing operation to said time-lined data structure.

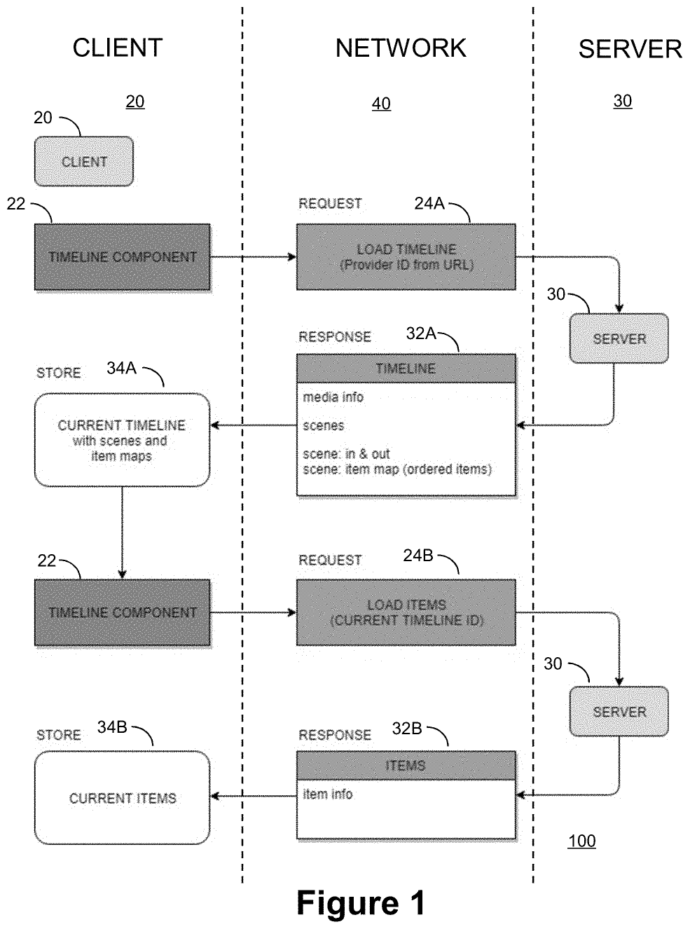

FIG. 1 is a block diagram illustrating non-limiting exemplary architecture in accordance with some embodiments of the present invention. System 100 may include a client 20 (possibly a smartphone or any other user terminal device) by which a human viewer or human listener (a user who is not shown here) may interface over network 40 (e.g., the internet) with server 30 that includes a computer processor (not shown here) by which some embodiments of the present invention are implemented.

According to some embodiments of the present invention, client 20 may include a timeline component 22, being a portion of the application on the client computer handling the multimedia file such as a movie watched by the user of client 20.

In operation, timeline component 22 may issue a request 24A to server 30 to load a respective timeline of the requested media. Server 30 determines the identity of requested media. This can be achieved either implicitly (e.g., using Auto Content Recognition (ACR) technologies or explicitly, by input provided by the user or based on an indicator embedded on the requested media file (For example the URL in the OTT platform itself where the media is being watched).

Server 30 then provides as a response, a timeline 32A being a data structure that is synchronized with the time code of the media requested. The timeline may possibly indicate metadata on media requested, may determine when scenes start (scene in), and when they end (scene out). For each scene, timeline 32A may include a map of the items (items being content items and production items) wherein the items are synchronized with the time code of the multimedia file.

According to some embodiments of the present invention, client 20 is then presented with and stores the current timeline 34A data structure that holds the above-mentioned synchronized mapping of the content and production items. The user may then watch/hear the media (show/movie/podcast) in conjunction with access to current timeline 34A and its synchronized data. It is noted that combined media and current timeline 34A may be accessed either on a same device (e.g. the smartphone or a laptop) or different devices (e.g., the movie is watched on a large screen and the time lined data is accesses over a mobile device).

Once request 24B has reached server 30, server 30 issues another response 32B with all the items requested. The loaded items are then stored as current items 34B which constitute the data of the items associated with current timeline 34A data structure.

Items 34B may be stored either locally on server 30 or on the cloud or any other location and can be updated and retrieved as per further requests from a plurality of users relating to a plurality of media files (e.g. different movies) at the same time.

According to some embodiments of the present invention, after items 34B have been stored, users can use client 20 to apply a search and/or edit operations to items 34B associated with current timeline 34A. Theses editing operations may include any of the following operations: create a new item, read an item, update an existing item, or delete an existing item. It is understood that any of these items may be either content related items or production related items.

According to some embodiments of the present invention, the time-lined data structure holds time-lined data on start and end times of scenes in the multimedia file.

According to some embodiments of the present invention, the identifying is carried out by automatic multimedia detection algorithm.

According to some embodiments of the present invention, the applying of the editing operation is carried out via a terminal other than a terminal by which the multimedia file is being watched.

According to some embodiments of the present invention, the editing operation is tagging a comment to a specified time point or time range within the multimedia file, to yield a time-tagged comment.

According to some embodiments of the present invention, the editing operation is at least one of: editing, adding, and deleting a time-tagged comment.

According to some embodiments of the present invention, the tagging is related to a scene.

According to some embodiments of the present invention, the time-lined data structure holds time-lined data on actors, background, plot, topics, characters, locations, music, dialogues, monologues, objects appearing in the multimedia files.

According to some embodiments of the present invention, the method further includes presenting, for at least some of the users, at least some of the meta data provided by at least some of the users over the multimedia file.

According to some embodiments of the present invention, the presenting is by way of text or graphics.

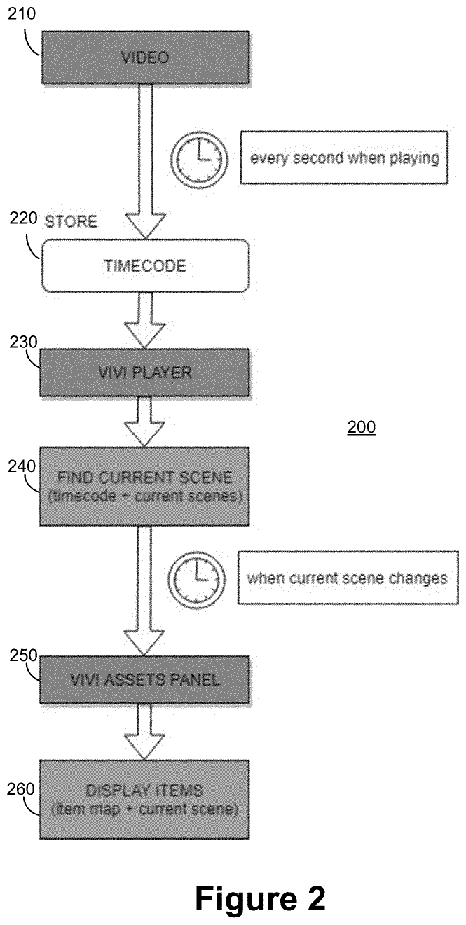

FIG. 2 is a high-level flowchart illustrating non-limiting exemplary user interface flow of the method in accordance with some embodiments of the present invention. Flow 200 illustrates a non-limiting user interface in which a video (e.g., a multimedia file) 210 is synchronized with timecode 220 and displays the relevant items based on the current time of the video. When video 210 is being consumed (e.g., watched), via a client device having a player 230 in accordance with embodiments of the present invention (e.g., “ViVi” player), a user may use a “find current scene” method 240 to browse through the various scenes associated with the timecode. Once a current scene changes (according to the current timecode of the media file being watched and the scene's timecode in the timeline) a panel of the various items associated with the current scene may be presented as an interface 250 (e.g. “ViVi” assets panel). These assets (items) may be edited as explained above (the CRUD operations) and the outcome may be displayed with “display items” method 260 in a manner that possibly maps the scene to the map of items.

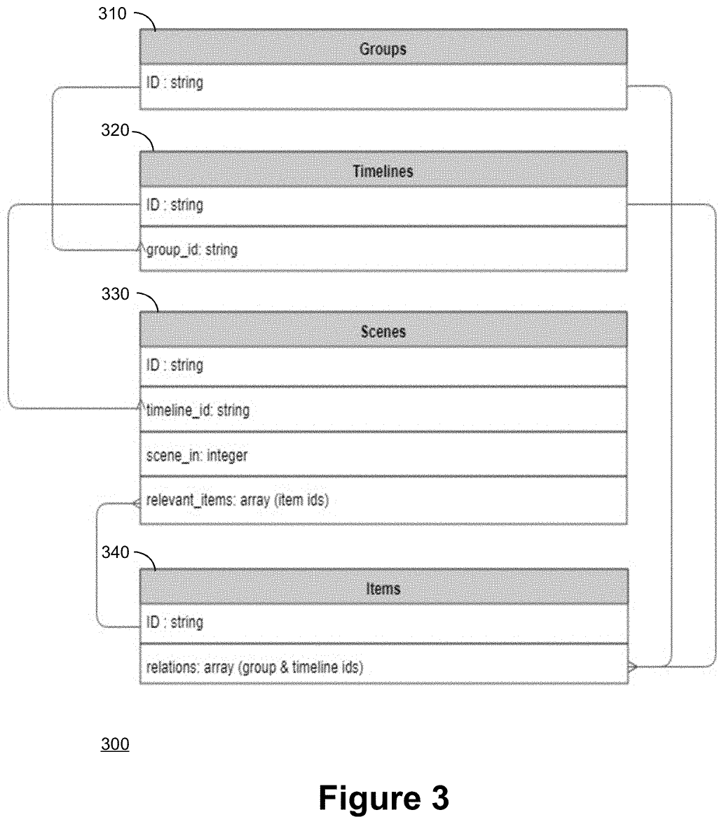

FIG. 3 is a diagram illustrating non-limiting exemplary architecture of the time lined data structure in accordance with embodiments of the present invention. Database collection 300 illustrates a non-limiting data structure showing groups 310 (e.g., various episodes of the same series). For each multimedia file of the group, a respective timeline 320 is allocated. For each timeline, there are related scenes 330 that may hold data on names of the scenes—when they start and end, and for each scene there is a respective array called items 340 that is associated with a plurality of items sorted by relevance. The relevance may be user defined or determined by set of predefined criteria such as appearance time or a more contextual ranking. The array called items 340 holds, inter alia, the occurrences of certain items in the various scenes.

It is understood, however, that database collection 300 is merely an example for implementing the time lined data structure in accordance with some embodiments of the present invention and that many other implementations may be used.

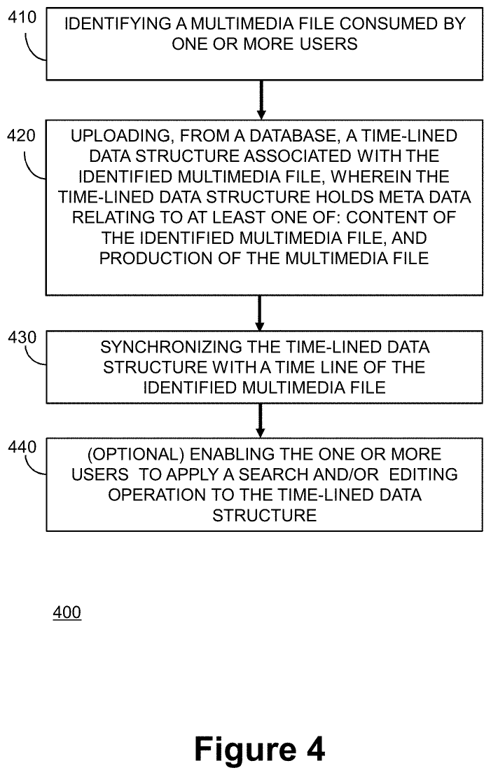

FIG. 4 is a high-level flowchart illustrating non-limiting exemplary method in accordance with some embodiments of the present invention. Method 400 may include the following steps: identifying a multimedia file consumed (watched or listened to) by one or more users 410; uploading, from a database, a time-lined data structure associated with the identified multimedia file, wherein said time-lined data structure holds metadata relating to at least one of: content of the identified multimedia file, and production of the multimedia file 420; and synchronizing the time-lined data structure with a time line of the identified multimedia file 430.

According to some embodiments of the present invention, method 400 may optionally include a step of enabling the one or more users to apply an editing operation (aka CRUD operations mentioned above) to said time-lined data structure.

In order to implement the method according to some embodiments of the present invention, a computer processor may receive instructions and data from a read-only memory or a random access memory or both. At least one of aforementioned steps is performed by at least one processor associated with a computer. The essential elements of a computer are a processor for executing instructions and one or more memories for storing instructions and data. Generally, a computer will also include, or be operatively coupled to communicate with, one or more mass storage devices for storing data files. Storage modules suitable for tangibly embodying computer program instructions and data include all forms of non-volatile memory, including by way of example semiconductor memory devices, such as EPROM, EEPROM, and flash memory devices and magneto-optic storage devices.

As will be appreciated by one skilled in the art, aspects of the present invention may be embodied as a system, method or computer program product. Accordingly, some aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, some aspects of the present invention may take the form of a computer program product embodied in one or more computer readable medium(s) having computer readable program code embodied thereon.

Any combination of one or more computer readable medium(s) may be utilized. The computer readable medium may be a non-transitory computer readable medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any non-tangible medium that can contain or store a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like, interpreted programming language such as Javascript and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Some aspects of the present invention are described above with reference to flowchart illustrations and/or portion diagrams of methods, apparatus (systems) and computer program products according to some embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram portion or portions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method of managing a time-based database for contextual operations, the method comprising:
identifying a multimedia file consumed by one or more users;
uploading, from a database, a time-lined data structure associated with the identified multimedia file, wherein said time-lined data structure holds meta data relating to at least one of: content of the identified multimedia file, and production of the multimedia file; and
synchronizing the time-lined data structure with a time line of the identified multimedia file.

2. The method according to claim 1, further comprising enabling the one or more users to apply an editing operation to said time-lined data structure.

3. The method according to claim 1, further comprising enabling the one or more users to apply a search operation to said time-lined data structure.

4. The method according to claim 1, wherein the time-lined data structure holds time-lined data on start and end times of scenes in the multimedia file.

5. The method according to claim 1, wherein the identifying is carried out by automatic multimedia detection algorithm.

6. The method according to claim 1, wherein the multimedia file comprises HTML 5 video tags, wherein the identifying is carried out based on said HTML 5 video tags.

7. The method according to claim 1, wherein the multimedia file is identified using Auto-Content Recognition (ACR).

8. The method according to claim 2, wherein the applying of the editing operation is carried out via a terminal other than a terminal by which the multimedia file is being consumed.

9. The method according to claim 3, wherein the applying of the search operation is carried out via a terminal other than a terminal by which the multimedia file is being consumed.

10. The method according to claim 2, wherein the editing operation is tagging a comment to a specified time point or time range within the multimedia file's timecode, to yield a time-tagged comment.

11. The method according to claim 2, wherein the editing operation comprises a set of at least one of: creating, reading, updating, deleting (CRUD), and voting.

12. The method according to claim 8, wherein the tagging is related to a scene.

13. The method according to claim 1, wherein the time-lined data structure holds time-lined data on actors, background, plot, topics, characters appearing in the multimedia files.

14. The method according to claim 1, further comprising presenting, for at least some of the users, at least some of the meta data provided by at least some of the users over the multimedia file.

15. The method according to claim 12, wherein the presenting is by way of text or graphics or moving picture.

16. A system for managing a time-based database for contextual operations, the system comprising:
a computer processor located on a server configured to identify a multimedia file consumed by one or more users over a client device; and
a database configured to store a plurality of time-lined data structures holding meta data relating to at least one of: content of the identified multimedia file, and production of the multimedia file,
wherein said computer processor is configured to upload, from said database, a time-lined data structure associated with the identified multimedia file, and
wherein said computer processor is further configured to synchronize the time-lined data structure with a time line of the identified multimedia file.

17. The system according to claim 16, wherein said computer processor is further configured to enable the one or more users to apply an editing operation to said time-lined data structure.

18. The system according to claim 16, wherein said computer processor is further configured to enable the one or more users to apply a search operation to said time-lined data structure.

19. The system according to claim 17, wherein the applying of the editing operation is carried out via a terminal other than a terminal by which the multimedia file is being consumed.

20. A non-transitory computer readable medium comprising a set of instructions that, when executed, cause at least one computer processor to:
identify a multimedia file consumed by one or more users over a client device;
store on a database a plurality of time-lined data structures holding meta data relating to at least one of: content of the identified multimedia file, and production of the multimedia file;
upload, from said database, a time-lined data structure associated with the identified multimedia file; and
synchronize the time-lined data structure with a time line of the identified multimedia file.
